(19) United States
(12) Patent Application Publication
(10) Pub. No.: US 2026/0030900 A1
(43) Pub. Date: Jan. 29, 2026

(54) Surveillance System

(71) Applicant: Motherson Innovations Company Limited, London (GB)

(72) Inventors: Romeo WIECZOREK, Stuttgart (DE); Matthias KOLLER, Stuttgart (DE)

(21) Appl. No.: 19/276,101

(22) Filed: Jul. 22, 2025

(30) Foreign Application Priority Data
Jul. 23, 2024 (DE) 10 2024 120 942.9

(51) Int. Cl. G06V 20/58; B60W 50/14; G06V 10/764; G06V 20/52

(52) U.S. Cl. CPC G06V 20/58; B60W 50/14; G06V 10/764; G06V 20/52; B60W 2420/403; B60W 2554/80

(57) ABSTRACT

A computer implemented method for a surveillance means (SM) of a vehicle, includes the following steps: recognizing at least one object via at least one SM, the SM recording image data of at least parts of the surroundings of the vehicle; determining, via the SM and/or the image data, properties of the object, the determining comprising a relative position to vehicle, of the object relative to the vehicle; tracking, via the SM and/or the image data, if the object has disappeared, preferably completely, from at least one surveillance area, SA of the SM at least partly, preferably completely, into a region not covered by the SA; monitoring, via the SM and/or the image data, if the object is going to be and/or is at completely outside a tracking area, the tracking area comprising the at least one region providing a signal to a driver of the vehicle and/or preventing or allowing a change of movement direction of the vehicle based on the tracking, monitoring, and/or the relative position of the object; a surveillance means, a vehicle, computer program as well as a computer-readable medium.

### CROSS-REFERENCE TO RELATED APPLICATION

This application claims priority to German Patent Application No. DE 10 2024 120 942.9, filed on Jul. 23, 2024, the entirety of which is incorporated herein by reference.

### FIELD

This disclosure relates to an artificial intelligence (AI) enhanced surveillance means (SM), in particular Camera Monitoring System (CMS), for vehicles, in particular trucks, and a method for operating the same.

### BACKGROUND

CMS become more and more common to either replace or supplement existing rearview systems. A CMS, for example, uses images recorded from different cameras positioned at rear view devices, the front, the rear, the side and/or behind the windshield. Based on these images the CMS provides the driver of a vehicle and/or an autonomous driving system, preferably together with other sensors, such as low range ultrasonic sensors or radar sensors, information about the surroundings of the vehicle to safely maneuver the same.

Once an obstacle, such as a trailer, is added to a vehicle, some of the SM, such as cameras of a CMS, in particular the rear camera, are not useful anymore, because they are at least partly covered by the obstacle. This is particularly the case for trucks towing huge trailers.

The US-Patent application 2022/0 314 884 describes a CMS system and a method, where a CMS system can be used with a trailer attached to the rear of a vehicle. However, this method requires that the trailer comprises at least one camera that can be implemented into or connected to the CMS of the towing vehicle.

### SUMMARY

Embodiments of the disclosure provide a SM that supports maneuvering a vehicle with an obstacle, such as a trailer, compensating reduced availability of SMs on a vehicle and/or lack of SMs, in particular cameras, on the respective obstacle, which is attached to the vehicle, such as, for example, a towed trailer.

This task may be solved in embodiments by a computer implemented method for a surveillance means, SM, of a vehicle, comprising the following steps:
Recognizing at least one object via at least one SM, the SM recording image data of at least parts of the surroundings of the vehicle;
Determining, via the SM and/or the image data, properties of the object, the determining comprising a relative position to vehicle, of the object relative to the vehicle;
Tracking, via the SM and/or the image data, if the object has disappeared, preferably completely, from at least one surveillance area, SA of the SM at least partly, preferably completely, into a region not covered by the SA;
Monitoring, via the SM and/or the image data, if the object is going to be and/or is at completely outside a tracking area, the tracking area comprising the at least one region;
Providing a signal to a driver of the vehicle and/or preventing or allowing a change of movement direction of the vehicle based on the tracking, monitoring, and/or the relative position of the object.

In embodiments, it is preferred that
(A) the relative position comprises a distance and/or trajectory;
(B) the region is a region on the rear of the vehicle and/or wherein the region is at least partly formed by at least one obstacle;
(C) the at least one tracking area additionally comprises the SA and/or
(D) the obstacle is a trailer and/or attachment to the vehicle, wherein more preferably the attachment is affixed via the trailer connector.

In embodiments, it is also proposed that
(A) the SM comprises one or more cameras and the one or more SA is one or more filed of views, FOVs, preferably of the cameras;
(B) the SM comprises a Camera Monitoring System, CMS;
(C) the region is at least partly formed as blind area between at least two SAs of the SM, where the at least two SAs have preferably an overlap; and/or
(D) the SA and/or the at least two SAs is/are monitoring the rear part of the vehicle; wherein preferably the SM or the CMS comprising at least on first camera and/or at least one second camera, wherein preferably the first camera and the second camera are positioned each at a rearview device or are part of, or forming a rearview device and/or the first camera is associated with the at least one FOV and the second camera is associated with the other FOV.

Embodiments of the method can be characterized in that
(A) the recognizing is aided by at least one first trained artificial intelligence model;
(B) the determining is aided by the first and/or at last one second trained artificial intelligence model;
(C) the tracking is aided by the first, second and/or at least one third trained artificial intelligence model; and/or
(D) the monitoring is aided by the first, second, third and/or at least one fourth trained artificial intelligence model.

Furthermore, in embodiments it is preferred that the recognizing and/or the determining further comprises: classifying the object into at least one object category, wherein especially one or more or each object category is assigned to a risk category, wherein preferably the signal to a driver of the vehicle and/or the preventing or the allowing of a change of movement direction of the vehicle is based on the risk category, wherein the object category preferably comprises at least one of: immovable objects, in particular traffic signs, barriers, buildings and/or the like, and movable objects, in particular pedestrians, vehicles, trucks, bicycles, motorcycles, trailers and/or the like and/or wherein the risk category comprises at least one of: normal, vulnerable and/or very vulnerable.

In an embodiment of the method the recognizing further comprises and/or the classifying the object into at least one object category comprises: Identifying and/or classifying the object recognized, preferably using in a database of standard objects, such as vehicle type, vehicle model, other standardized objects of traffic infrastructure, such as traffic signs, and/or map data, wherein especially the identifying is supported by at least one of the first to fourth artificial intelligence model and/or a fifth artificial intelligence model.

In the before described embodiments it may be preferred that at least one of the first, second, third, fourth and/or fifth artificial intelligence model is a neural network, NN, in particular a transversal neural network, TNN and/or a classification algorithm; and/or wherein the training data of any combination of the first to fifth artificial intelligence model comprises:
(A) image data, in particular images, of different objects that move into the region via at least partly crossing and/or partly moving into one or more SAs of one or more SMs of different vehicles at different distances and/or with different trajectories relative to the vehicles; and/or
(B) image data, in particular images, using different obstacles.

Embodiments of the method can also be characterized in that the determining further comprises:
determining at least one of: the dimensions of the object, the relative velocity of the object relative to the object and/or an object type; and/or
saving at least partly, preferably completely, the properties of the object, preferably for and/or during the monitoring and/or tracking; and/or
wherein the tracking further comprises:
determining based on the properties of the object at least one of: a minimal distance relative to the vehicle and/or a maximum dimension, in particular maximum width, maximum height and/or maximum length of the object; and/or
saving the minimal distance and the maximum dimension, preferably for and/or during the monitoring and/or tracking.

In embodiments, it is also proposed that the method further comprises receiving/acquiring, preferably from a database:
dimensions of the obstacle, in particular width, height and/or length,
dimensions of vehicle, in particular width, height and/or length,
the position of the SM, in particular the first and/or second camera, on the vehicle and/or
the position of rearview devices carrying the first and/or second camera; and/or
   wherein the method further comprises:
   Defining the region based on at least one of:
dimensions of the obstacle, in particular width, height and/or length,
dimensions of vehicle, in particular width, height and/or length,
the position of the SM, in particular the first and/or second camera on the vehicle and/or
the position of rearview devices carrying the first and/or second camera; and/or
the overlap of the at least two SA, which preferably defines the distal end of the region relative to the vehicle.

Furthermore, in embodiments it is preferred that the method further comprises
Adjusting the region based at least on one of:
the trajectory of the vehicle, wherein preferably the SA and/or the at least two SAs are changed due to the vehicle changing its steering direction and/or movement direction;
the obstacle dimensions; and/or
the overlap of the at least two SA, which preferably defines the distal end of the region relative to the vehicle.

In embodiments, the method can be characterized in that providing a signal further comprises
(A) determining that the object is at least partly in the region before providing the signal in form of a first signal or preventing change of movement direction;
(B) determining that the object has left the region entirely before providing the signal in form of a second signal or allowing a change of movement direction; and/or
(C) constructing the signal as birds eye view from the image data of the SM, wherein preferably the region is visualized based on the determining.

Also, in embodiments it is preferred that
monitoring and/or the determining that the object is at least partly in the region and/or the determining that the object has left the region entirely before providing the signal in form of a second signal or allowing a change of movement direction, is based on a prediction, preferably using the object properties and/or is based at least one of:
The object properties, in particular the maximum dimension of the object, in particular maximum width and/or maximum length,
the minimal distance relative to the vehicle,
a minimal distance threshold depending on the obstacle dimension, in particular the minimal distance threshold;
the dimensions of the obstacle, in particular width, height and/or length;
the dimensions of vehicle, in particular width, height and/or length;
the position of the SM, in particular the first and/or second camera on the vehicle and/or the position of rearview devices carrying the first and/or second camera; and/or.
the overlap, which preferably defines the distal end of the region relative to the vehicle, wherein further preferred the distance upon overlap is determined and provides a maximum distance threshold.

Finally it is proposed that embodiments of the method further comprises evaluating at least one sensor information for determining that the object is at least partly in the region, wherein preferably the at least one sensor information is provided by the vehicle and/or the obstacle and/or is at least one of: park distance control sensor, GPS, radar signal, a laser signal, especially a LIDAR signal, and/or the like; and/or that the method further comprises cleaning the object from a memory of the SM, based on the monitoring and/or the relative position in particular after determining that the object has left the tracking area entirely.

Further, the embodiments of the disclosure provide in a second aspect a surveillance means, SM, in particular for a vehicle, preferably comprising one or more processors in operational connection with at least one memory, the SM and/or one or more processors are configured to conduct the method as described before.

It is proposed that embodiments of the SM comprises at least one CMS and/or one or more cameras, in particular a first and a second camera, preferably positioned each at a rear view device and/or wherein the SM and/further comprises at least one sensor, preferably a park distance control sensor, GPS sensor, a radar sensor, a laser sensor, especially a LIDAR, and/or the like, wherein preferably the sensor is positioned on the vehicle and/or the obstacle.

Embodiments also provide in a third aspect a vehicle, in particular a truck, configured with at least one SM and configured to conduct the before described method

Furthermore, a computer program comprising instructions which, when the program is executed by a computer, cause the computer to carry out the before described method is provided.

Finally, a computer-readable medium comprising instructions which, when executed by a computer, cause the computer to carry out the before described method is provided.

Surveillance means (SM) in accordance with this disclosure may be any image recording device or system, such as a CMS, a camera system and/or a camera suitable to acquire image data, especially based on electromagnetic waves.

Surveillance area (SA) may be any area that is actively monitored by the surveillance means. This could be, for example, one or more fields of view (FOV) of a camera or other means. The SA may usually cover the at least partly the surroundings of the vehicle.

Region may refer to the area that is not part of the SA. For example, the area covered by the obstacle and/or the area behind the obstacle with respect to one or more surveillance areas can be part of the region. The region may additionally or alternatively include blind spots or areas that are, for example, between the surveillance areas, such as for example, FOVs of different cameras of a CMS. The region may be limited by flanks, which may define at least partly the delimitation of the region to at least one, preferably adjacent, SA.

Image data and/or the images, for example, acquired by the SM can be analyzed by artificial intelligence model, e.g. a trained neural network (NN), in particular a transversal neural network. Transversal neural networks (TNN) can be used to determine the distance of an object and/or objects surface in a camera image. TNNs are special neural network architectures developed to model spatial information and solve tasks such as distance determination or depth perception. There are different approaches how TNN can be used for distance estimation. One commonly used method is the use of so-called depth estimation networks based on TNN. These networks are trained with large amounts of coupled images and depth information to capture the spatial relationships between the pixels. Depth estimation networks take a (camera) image as input and generate a corresponding image of depth information as output. By analyzing the spatial features and patterns in the images, they can estimate how far away the objects in the image are. In this way, objects that have not yet completely disappeared from the view can still be measured in distance and reconstructed in their full extent in the bird's eye view.

Training data for the one or more artificial intelligence models can comprise, for example, surveillance data, such as camera images, of and/or acquired by an SM, such as an CMS. Additionally, distance and/or size information and/or measurements of and/or acquired by a distance sensor, such as radar sensor, a LIDAR sensor and/or the like may supplement the training data. In particular, the training data comprises surveillance data of the surroundings of the vehicle, in particular the rear of the vehicle. The SM and/or one or more distance sensors can be calibrated to each other so that a common coordinate system can be described.

Training data in particular comprises data related to objects that may follow and/or move relative to the vehicle, such as other vehicles, for example, cars, trucks, motorcycles, and/or busses.). Furthermore, training data can be recorded with different trailer lengths and types.

A distance and/or size information can be obtained by using either the one or more additional distance sensors and/or by using objects in the surveillance area of the provided training data that have a standardized and therefore recognizable size, such as, side boundary posts, license plates, and/or the like other). Additionally and/or alternatively also a lane recognition can be used for distance determination, where preferably a lane detection is made via detection of the center line and side boundary line/bar.

The distance, dimension and/or size information may be added to corresponding SM recordings, which can be images, via a labeling process in order to train the one or more artificial intelligence models and to enable the one or more artificial intelligence models to infer the distance based on the image information, preferably without using further distance sensors. The labeling process for the training data may also include the object category, such as immovable objects, in particular traffic signs, barriers, buildings and/or the like, and movable objects, in particular pedestrians, vehicles, trucks, bicycles, motorcycles, trailers and/or the like. Also, a risk category may be labeled. The latter can be indicative how vulnerable the object is with respect to collisions.

In the labeling process and the subsequent application of the trained model the intersection point P1, where at least two SA of the one or more surveillance means overlap may of particular importance. This point determines and/or limits the depth of blind area, for which the artificial model is to be applied. Furthermore, it is advantageous to use P1 (i.e the distance that is farther away than P1 from the vehicle) for object recognition and prediction, because they can be fully recognized there as they are better or even fully covered by SM in the overlapping SA.

Also relevant in the labeling process and/or for subsequent application of the trained models can be the used vehicle and/or obstacle. For both, more preferably the dimension, in particular the length, width and/or height that may at least partly define the coverage of the SA by the obstacle are of importance. They may be included in the training data and/or in a pre-calibration of the trained system. Additionally and/or alternatively, the labeling may also include the lane detection, for example, in order to define the operational boundaries of the model, where the operational boundaries could represent at last partly and/or completely the tracking area and/or to define a reference for the distance determination. This can be also used in the application of the trained artificial intelligence model.

The training data can be either provided per SM or SA in a dedicated stream, or it can be provided in a merged stream. The training data as well as the data stream during application of model can be normalized before provided to the neural network. Also respective pre-filter, such as image filters, can be applied.

A vehicle according to the disclosure may be any vehicle usable for transportation of goods or people. In particular a vehicle in accordance with the disclosure are passenger vehicles and/or trucks with means, such as trailer hitch for attaching obstacles.

The movement direction may be any direction or trajectory on which the vehicle is moving. In particular the movement direction refers to component of the actual movement vector, which indicates that the vehicle drives either forward or rearward.

The steering direction may generally refer to a movement change of a vehicle that indicates a direction change due to steering action.

The method, system and vehicle described herein may have the advantage that obstacles, such as a trailer, semi-trailer and/or other attachments that can, for example, be attached to the trailer hitch of a vehicle, do not prevent surveillance means, such as CMS and/or other driving assistance devices from properly functioning, because the obstacle is for example covering at least a part of the surroundings that are monitored by respective SM. This can be in particular the case for at least one camera of a CMS, which is placed on a rearview device and/or monitors the rear of the vehicle.

This will become more apparent when considering a truck trailer as example for an obstacle attached to the vehicle. Attaching a trailer to the vehicle may cover at least partly the surveillance area, such as the FOV of one camera of the CMS. Other cameras of a CMS that are positioned at the rear of the vehicle, e.g. at the trunk and or near the trailer hitch would be covered by such a trailer, which is attached to the trailer hitch, almost entirely. This may negatively affect the functioning of the complete surveillance means, e.g. a CMS system of the vehicle.

Attaching additional sensors and/or SMs to the obstacle (e.g. the trailer), such may provide a solution. An example would be attaching an additional rear camera on the trailer This solution has, however, disadvantages: First, it requires refitting of the trailer or obstacle with a surveillance means and/or camera that is compatible to the SM (e.g. a CMS) of the towing vehicle. This can incur further refitting requirements, depending on the respective vehicle type or vehicle manufacturer towing the trailer. Second, the existing SM is to be further calibrated using the additional SM. Overall, this reduces flexibility regarding the operation of the trailer with different towing vehicles and incurs further costs.

Embodiments of the above described method does not need any further hardware to keep the SM of the towing vehicle, which is preferably in one example a truck and/or tractor, operational, but allows at the same time to reduce the collision risk substantially by evaluating historical data and/or real time data from SM covering areas and/or boundaries around the region that is covered by the obstacle.

By including an object recognition and monitoring as well as tracking of respective recognized objects with respect to their relative position (in time) to the vehicle, by, for example, determining respective properties, such as distance and/or trajectory, of recognized object, the method provides an effective way to overcome the limitations introduced by attaching and/or connecting an obstacle to a vehicle.

The region that is not covered (anymore) by the SA of the SM, such as the respective FOVs of a vehicle camera system or camera, due to the attached and/or connected obstacle can still be examined by anticipating or predicting from the object's properties and/or from tracking of the (remaining) SA, such as the FOV of the camera system whether the object is located in the region.

By, preferably firstly, tracking whether the recognized object has at least partly or completely disappeared in the region from the area subject to surveillance by SM, it is assured that only respective objects relevant to the region are further monitored and objects that do not interfere with the region are not further considered. This allows an improved efficiency and allocation of computing power to respective objects of interest with reference to the region.

The result of the proposed method, the signal to the driver and/or respective refraining from allowing direction changes increases the security of the vehicle, the object, in particular in the region, the obstacle and/or other surroundings.

Using one or more, in particular a first and a second, camera as SM a better evaluation of the region can be performed. This is in particular the case where a first and a second camera have overlapping SA such as the FOVs of first and second camera, wherein in between preferably the region is located, for example as a blind area. This allows to monitor, preferably at the same time, more than one flank of the region, and to which objects can enter the region.

Using one or more artificial intelligence models enables a further enhancement of object recognition, object property determination, in particular relative position, preferably distance and/or trajectory determination. The same may apply to the determination, in particular anticipation and/or prediction of the at least one objects relative position or its trajectory, for example. Using specialized model for each step separately may also provide an advantage regarding the model AI model design. Different AI methods can be used depending on the method step and/or task.

Using artificial intelligence models, such as NNs, in particular TNNs, allow, for example, to easily extract properties of an object in an image and/or recording of the camera system, in particular one first and/or second camera of the camera system. Using a TNN with special neural network architectures developed to model spatial information and solve tasks such distance and/or trajectory determination and/or depth perception facilitate the extraction of the necessary properties from images of the SA, which is in particular adjacent to the region.

Furthermore, using TNN allows to dispense from using additional sensors that provide depth information, such as LIDAR or radar sensor, as explained already above.

Further, these models can be used to supplement additional information that further facilitate the accuracy of the object's surveillance in the region.

Determining further properties of the object, and particular it's width and/or other dimensions, relative velocity and/or type (classification), allows to increase accuracy, and particular selectivity and sensitivity of the method with regard to the object's position in the region.

The same can also apply to further information of the speaker and/or the obstacle that can be considered, such as the dimensions of the vehicle and/or the obstacle, the position of the camera system, in particular the first and/or the second camera, and/or review devices carrying the respective camera and/or cameras of the camera system.

Calculating a maximum object width and/or a minimal distance to the vehicle (preferably including the connected and/or attached obstacle) provides an additional safeguard regarding the object location in case that it completely disappeared in the region.

Considering one or more or all available information, properties and/or the like of vehicle, obstacle and/or object acquired, received, determined and/or available allows an overall determination, in particular prediction, of the object position. This further increases the security concerning the vehicle and the obstacle as well as their surroundings.

Using additional sensor data such as sensor data from one or more LIDAR sensors, laser sensors parking control sensors, e.g. ultrasonic sensors, radar sensors and/or position sensors, e.g. GPS sensors and/or the like supports a further refined object determination. This can be further supplemented by using map information or a reference database that allows classification of the recognized object.

For example, respective constructional objects, such as buildings and/or different traffic infrastructure items (traffic signs and/or the like) and their relative position to the vehicle can be easily identified using map materials and the position of the vehicle. Another example is the classification of an object, in particular in case the object is a vehicle, using preferably a respective database providing details about dimensions. Classifying objects helps to gather further information regarding the properties, in particular the dimensions, which further fosters the position determination of the object in the region, when used for tracking and monitoring objects.

Classifying objects into different object categories, such as immovable objects, in particular traffic signs, barriers, buildings and/or the like, and movable objects, in particular pedestrians, vehicles, trucks, bicycles, motorcycles, trailers and/or the like, can be used also for a risk assessment for providing different signal depending which object category entered the region, which is not covered by the SM due to the obstacle.

The foregoing summary, as well as the following detailed description, will be better understood when read in conjunction with the appended drawings. For the purpose of illustration, certain examples of the present disclosure are shown in the drawings. It should be understood, however, that the present disclosure is not limited to the precise arrangements and instrumentalities shown.

### BRIEF DESCRIPTION OF THE DRAWINGS

The accompanying drawings, which are incorporated in and constitute a part of this specification, illustrate an implementation of system, apparatuses, and methods consistent with the present disclosure and, together with the detailed description, serve to explain advantages and principles consistent with the present disclosure, wherein:

FIG. 1 shows an exemplary embodiment of the method as described herein;

FIG. 2 is a birds eye view of a schematic demonstration of a CMS that implements the method according to the invention on a truck with a trailer;

FIG. 3 is a birds eye view of a schematic demonstration of the embodiment of FIG. 1, where the track conducts a change in the steering direction, here to the right hand;

FIG. 4 is a birds eye view of a schematic demonstration of the embodiment of FIG. 1, where a minimum distance of an object in the region is determined; and

FIG. 5 is a partial birds eye view of a schematic demonstration of the embodiment of FIG. 1, where a refined distance recognition is shown.

### DETAILED DESCRIPTION

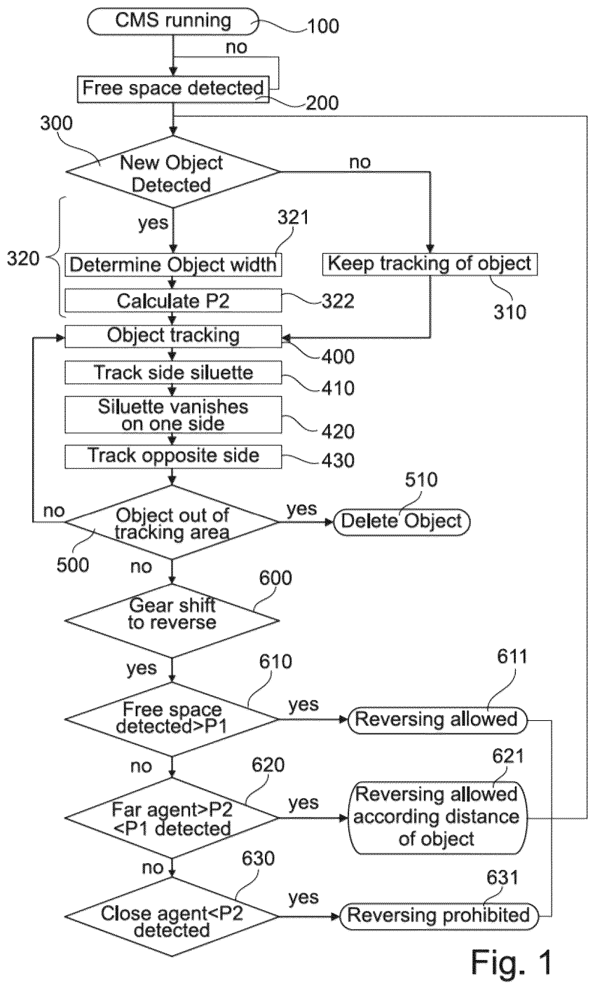

The exemplary method as demonstrated in the diagram of FIG. 1 shows one implementation of the method as described herein. At 100, while the SM in form of an CMS is running, a region, which is not covered by any SM, preferably comprising one or more first and/or second cameras, or its SA, preferably FOV of first and second camera can be detected.

At 200, this detection can be automatically, for example if an engagement of the trailer hitch of the vehicle is recognized and/or a permanent coverage of one or more field of views is recognized. This can be conducted for example by a processor which is part of the CMS in combination with the one or more surveillance means, preferably using an AI supplemented recognition method, such as a trained NN and/or TNN.

Further, the SM may comprise one or more processors and respective memories in operative connection that may also conduct the one or more or all method steps as described herein.

At 200, once a region, also referred to as free space and/or blind region, is detected, the method can proceed with further steps.

Alternatively, the method may also start the object recognition directly, especially without any triggering by a detection of a free space or blind region.

At 300, a new object/the step of recognizing at least one object by the SM is conducted.

If a recognized object that is already known, for example, because the known object entered the SA of the SM, which may be for example the FOV of one camera of the SM, in particular the first and/or second camera, and/or entered at least partly, preferably completely, the region, blind region and/or free space, respectively, already before the method may directly keep tracking of this already known object, step 310. In such cases at least the object and the previously determined parameters are retrieved from at least one memory and/or a local and/or cloud data base upon identification. Furthermore, the method may include acquiring (additional) properties of the known object, in particular if respective information cannot be retrieved from the memory and/or database. However, the determination of properties about the relative position may be always conducted. Further, in particular, if new information is determined, the memory and/or the data base can be updated accordingly.

At 300, if the recognized object is a new object, the method will continue with a determining step 320. During the determining step 320 properties including at least a relative position to the vehicle of the recognized object can be determined from the image data that the SM has recorded. This can, for example, include a distance and/or a trajectory of the object relative to the vehicle, but also additional parameters such as the dimensions of the object (e.g. its width, step 321), the relative velocity of the object relative to the vehicle and/or an object type. The parameters can be saved for example in a data base associated to the vehicle and/or the SM in an additional step so that they can be used for further determinations of parameters, predictions relating to the region, blind area and/or free space.

In one embodiment the object and/or its properties of the object are saved, in particular on the memory and/or the data base, during the monitoring process until the object is out of the tracking area, which particular means that the object is going to be and/or is completely outside the region and the SA.

In a further intermediate step the method may proceed with determining based on the properties of the object at least one of: a minimal distance relative to the vehicle and/or a maximum dimension of the object. These determined parameters can be saved, preferably during the object tracking and/or until the object has left the region and/or the tracking area especially using the memory and/or the data base.

The minimal distance hereby may refer to a distance P2, upon which, based on the depth information and/or dimensional information of the recordings of the SM, the part and/or surface facing and/or being nearest to the vehicle and/or obstacle attached to the vehicle is completely disappeared in the region/blind area/free space.

The method may also include in one embodiment classifying objects, preferably a classifier to categorize objects, into different object categories, such as immovable objects, in particular traffic signs, barriers, buildings and/or the like, and movable objects, in particular pedestrians, vehicles, trucks, bicycles, motorcycles, trailers and/or the like. Based on such classification a further risk/damage assessment can be conducted via risk category assessment.

The method continues with tracking 400 the object, in particular if the object disappeared preferably completely from the at least one SA of the SM at least partly, preferably completely, into the region, which is, for example, not covered by the SA of the SM due to the obstacle attached to the vehicle, wherein the region and/or the at least one SA, such as one or more FOVs, may be part of a tracking area. This can be aided by using a trained NN, in particular a TNN.

To decide if that's the case, i.e. that the object is within the tracking area and/or region the methods may implement several intermediate steps: in one example the method may include tracking the site silhouette of the object, step 410. Additionally or alternatively the vanishing and or disappearing of the object silhouette on one side of the tracking area, in particular at least one flank of the SA, e.g. the field of view of the camera, that is adjacent to the region, can be monitored, step 420. Still alternatively or additionally, in particular in cases where the surveillance means comprises at least two cameras: a first camera and a second camera, the FOVs of a second camera, which is on the opposite flank of the blind area/the region/the free space with respect to the FOV of the first camera can be monitored to determine if the object has partly or completely entered tracking area in particular the region, step 430. The latter example can also be applied more generally to at least two SAs, in between which the region is located.

The method may continue monitoring 500 by the SM if the object is going to be and/or is completely outside the tracking area and/or the region. In one example, this can be conducted using the same intermediate steps that can be used for determining if the object is within the tracking area and or the region. Furthermore, the method may implement as intermediate step or measure, monitoring one or more flanks of the one or more SA, e.g. FOVs of one or more cameras of the SM, which are not adjacent to the region/blind area/free space, and/or that represent the limits of the tracking area if a respective side silhouette of an object, which indicates that the object is outside the region, and/or the complete silhouette vanishes and/or disappears on one of these flanks. When using such additional SM, which have a SA not adjacent to the region, furthermore, a geometrical relation to the region may be input, and may be used to analyze the respective information.

Returning to 500, if that is the case, i.e. the object has left the tracking area, which is for example formed of the at least one SA and the region or only the region, the object can be deleted from the memory (of the SM) and/or the data base, step 510. Alternatively or additionally, in particular if the object was classified as moving object, for example, as another vehicle during the object recognition step 100, respective moving objects can be saved in case they reappear in the tracking area. This has the advantage that computing power with respect to already determined and recognized objects can be saved and the object recognition is sped up.

The method may in one embodiment also include counting classified objects per object category and/or risk category. For example, the method may include during the tracking 400 counting the objects per category or per risk category that disappeared preferably completely from the at least one SA of the SM at least partly, preferably completely, into the region. The method may then continue subtracting objects of the same category (object category and/or risk category) during monitoring if and once such objects left the tracking area, which is for example formed of the at least one SA and the region or only the region. By providing the number of objects in the region a simple information can be provided, for example as part of the signal to the driver, which objects and/or objects with risk category are within the region, which is described further below.

Notably, the method may include preventing any negative counts of similar objects. For example, objects of a distinct object class determined by a classifier, such as pedestrians, can be counted when entering and/or leaving the region. Negative counts are however not allowed to increase safety with respect to situations where pedestrians leave or enter a car for example.

Furthermore, the method may continue with providing a signal to a driver of the vehicle and/or allowing a change of movement direction of the vehicle based on the monitoring, the tracking and/or relative position result, in particular in case a change of the movement direction is immanent due to, for example, a shift from a forward gear to a reverse gear, step 600.

That means in case the object has left the tracking area and/or the region/free space/blind area, for example, because its distance to the vehicle is bigger than a certain threshold, P1, step 610, the vehicle is automatically allowed to change its movement direction, step 611, for example by changing forward gear to reverse gear.

Additionally or alternatively a respective signal indicating that the region is free from objects, which could provoke a collision with the vehicle if the movement direction was changed, can be provided. This can be in particular a visual and/or acoustic indicator for the driver.

In case that the object tracking 400 and monitoring 500 provides that an object is within the tracking area and/or more particularly in the region, e.g. the relative distance is below R1, the vehicle may not be allowed to change its movement direction to prevent a collision with the object. Furthermore, a signal may be provided to the driver indicating that a collision is likely and/or imminent if the movement direction of the vehicle was changed.

In another example additionally or alternatively the movement direction can be also prevented in case a certain object category determined by the classifier is within the tracking area and/or blind region. This case could be for example for immovable objects or pedestrians. Using categories and respective classifiers allows detecting distinct high risk and/or vulnerable objects such as pedestrians by assigning a respective risk category, such as vulnerable to cyclists and very vulnerable to pedestrians, to object category. By applying stricter rules, depending on the object category and/or the assigned risk category, such as no direction change (e.g. reversing), the method can significantly reduce the risk of damaging or harming persons or other vulnerable objects.

In this respect if movement direction change is initialized, for example, by a gear shift to reverse from the driver, step 600, the method may further distinguish in accordance with the object tracking, whether the object is within the minimal distance R2 or not, step 620. In the latter case a movement can be allowed up to a certain degree in accordance as long as the vehicle moves within the minimal distance P2, step 621. Once the minimal distance is reached a further movement of the vehicle can be automatically stopped by the SM or by indication of the SM, steps 630 and 631.

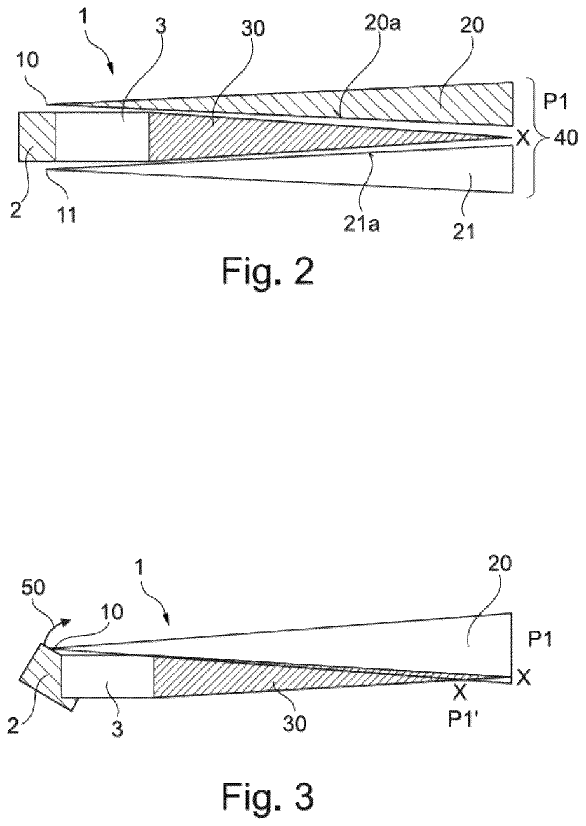

FIG. 2 shows a bird's eye view of an exemplary SM 1 in accordance with the disclosure. Shown here is a truck 2 with a trailer 3, the truck having two cameras 10, 11 that form in this example the SM 1 as CMS. The two cameras 10, 11 are located on either side of the truck 2, for example, one camera can be attached or carried by a respective rearview device on each side of the truck. The respective FOV's 20, 21 of the cameras 10, 11 forming part of the SA 40 are indicated in FIG. 2. In between and on the rear part of the truck 2, because the trailer 3 of the truck 2 in this example has no rear camera and furthermore forms an obstacle, a blind area or region 30 is formed. The region 30 forms together with the FOVs the tracking area in this example. Each camera FOV 20, 21 has a flank 20a, 21a adjacent to this blind area 30. The blind area 30 corresponds to a region that is subject to surveillance of the CMS despite that it is not directly covered by any camera. The distance P1, (to which in at least one example, also the above method refers to) in the example of FIG. 2 is the distance upon which the FOV's 20, 21 of the two cameras overlap. By this overlap the region/blind area 30 is limited in depth. Any object having a relative position, in particular the distance, that is farther away than P1 may be subject to object recognition and determining of its relative position in accordance with the above described method, but may only be tracked and monitored if it's relative position to the vehicle, in particular the distance d, is determined as being or becoming than P1 (d≤P1). Respectively, P1 may also referred to as maximum distance threshold. In that regard a change of the movement direction, for example from forward to reverse, also triggers monitoring and tracking and may additionally provide a further signal to the driver warning about a potential collision if the object based on its relative position, in particular its trajectory, and or the trajectory of the vehicle is about to collide with the trailer and/or the vehicle itself. Alternatively or additionally based on the relative position of vehicle and object that is closer than P1 and/or is getting closer than P1 an emergency brake could be triggered once the tracking determines that otherwise a collision would be unavoidable. Such a determination can be supported and/or aided by additional properties and or a prediction of the objects in vehicle position as described herein.

Finally the signal provided to the driver, which preferably warns about a respective collision risk, can be a simple acoustic signal, a warning lamp and/or the like. Additionally or alternatively, a view, such as a birds eye view, can be presented to the driver indicating the recognized objects, preferably with their anticipated position.

In one embodiment the method may include an extended surveillance mode, which could be activated even if the vehicle is not in ignition or pre-ignition state. In such case the method may not only be up and running during vehicle operation but also during (short time) parking or other breaks. Additionally or alternatively the method may also include before starting, in particular the vehicle, indicating a warning to the driver that the activity around the region was un-monitored. Additionally a respective reset of the memory and/or data base, in particular concerning the objects within the region, may be conducted.

FIG. 3 shows the embodiment of FIG. 2, where the steering direction 50 of the truck 2 has been changed to the right, considering the forward direction. This leads to a different distance P1′ with regard to the blind area 30. The method therefore may include further adjusting the dimensions and/or borders of the region dynamically. For example, the region can be dynamically expanded or reduced in accordance with the change of the one or more SAs, for example the FOVs of first and second camera 10, 11. In that respect also different objects may become relevant for object recognition and subsequent tracking and monitoring.

The method may further include cleaning the saved objects, for example from memory (of the CMS) and/or the data base, in response to a steering direction change. Additionally or alternatively one or more objects that are recognized during the steering operation may be saved only temporarily until the steering operation has concluded. If also a change in movement direction is conducted the relative position of the object within P1 may be considered with regard to the trajectory of the vehicle due to the steering into a different direction this can then trigger allowance of movement direction change despite the presence of the object within the tracking area 40 and/or the blind area/the region 30.

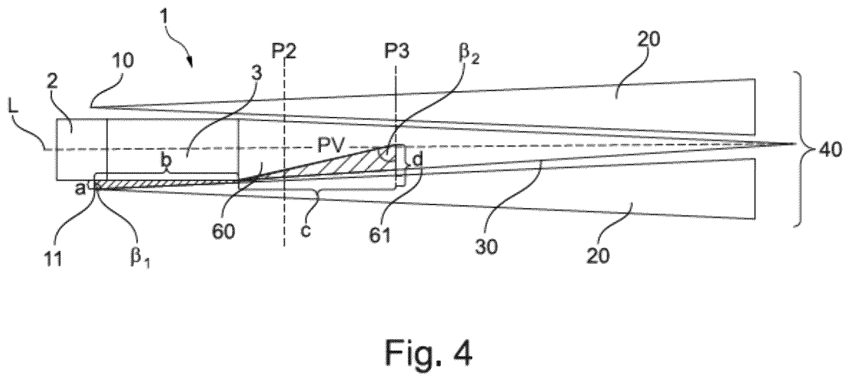

FIG. 4 is a representation of the example of FIGS. 1 and 2 where the concept of P2 is demonstrated for an object PV. As apparent from the schematic of FIG. 4, P2 is the distance of a distinct object PV that has been recognized and of which properties regarding its dimensions have been determined, for example, by the means and method as described above, to the obstacle and/or vehicle. Furthermore the trajectory of PV can be determined as part of its relative position during the object determining.

P2 is the distance where the front 60 facing towards the vehicle completely disappears in the blind area/region. P2 can for example be calculated using the dimensions of the vehicle, the obstacle, the object itself as well as the position of the CMS, in particular one or more cameras of the CMS. In particular, the objects width, especially the objects front width, is of importance for this calculation, as P2 directly depends thereon.

P3 on the other hand is the distance upon which the object PV completely disappears. For example P3 is the distance corresponding to the rear face 61 of the object PV farthest away from the vehicle when object PV just disappears in the blind region/area. In other examples P3 is defined by the widest section of the objects, e.g. the rear view mirrors of the vehicle. Therefore, P3 is of particular relevance as it defines the distance upon which the object PV completely disappears in the blind area/region. If the object PV gets closer to the vehicle the tracking of the object PV may be only conducted via prediction and/or approximation based on the data collected/recorded by the SM previously in time. This is in particular the case if the obstacle, such as a trailer does not comprise any additional sensor, such as distance control sensors.

To determine P3, the following steps may be conducted: Firstly, define the width, in particular the maximum width, of the object PV and, preferably, at least tracking at least one edge (e.g. rearview mirror or outmost edge) of the object PV that does not disappear behind the obstacle. Second, defining, based on the width, P3 and preferably determining the possible distance of the object PV to the obstacle 3 and/or vehicle when the object PV just has completely disappeared.

P3 can be for example 15 m for an obstacle's width of 2 m and a distance of the cameras of the CMS from the vehicle of 0.25 m as well as a width of the vehicle of 2.5 m. This can be achieved and/or approximated by the following geometrical consideration, which assumes that vehicle 1, obstacle 3 and object PV are aligned on a center line L and that one camera or other surveillance means is attached to one side of the vehicle:

$$tan {β}_{1} = tan {β}_{2} = \frac{b}{a} = \frac{c}{d} ⟹ c = \frac{b}{a} d ,$$

where β₁ and β₂ are the angles formed by two the triangles, respectively, which in case of β₁ depends on the distance (a) of one camera to the vehicle and the obstacle and/or vehicle length (b) and which in case of β₂ depends on the obstacle and/or vehicle width (d), not including the distance to one camera (a). Where in one example, which is shown in FIG. 3:

$$d = \frac{T}{2} - \frac{A}{2} ⟹ c = \frac{b}{a} ( \frac{T}{2} - \frac{A}{2} ) ,$$

where T is the width of the vehicle (truck) and A is the width of the object PV.

P3 may also be used to calculate P2 based on the object's dimensions. For example, P2 could be defined as the P3 subtracted by the total length of the object or subtracted by the length (of the widest section of the object corresponding to P3) to the front face. One or more respective machine learning and/or AI models (e.g. trained neural networks as described above) may aid such determination.

In one embodiment P2 may only be used for potential collision as long as the object PV is not completely disappeared, i.e. not closer than P3. In such scenario, the determination of P2 is still possible. When the object PV is completely within the region, e.g. <P3, P2 may not be determined with enough certainty/accuracy. In such case the method would not allow a respective movement direction change of the vehicle that will lead into the (blind) region. As such, a reversing may be completely prohibited.

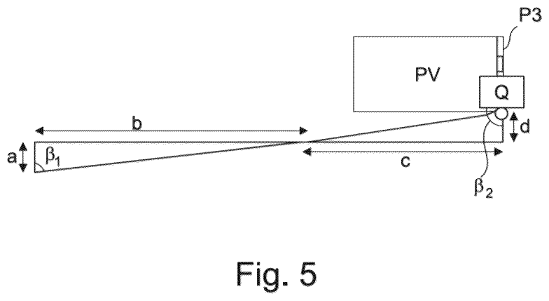

In FIG. 5 a refined determination of P3 is further demonstrated. The geometrical considerations correspond to FIG. 4 and are shown here only in relation to the object PV. However, d is not the vehicle's or the object's width, but the distance to the rear outermost edge of the obstacle, which could be recognized by the surveillance means, like the camera, which is in distance a to the vehicle with obstacle (e.g. a truck with a trailer) having a length of b. Using this outermost rear point Q allows an easy recognition by age and/or corner detection, which is preferably supported by machine learning and/or AI (like neural networks or the like). For example one model as described above could be used.

It will be appreciated by those skilled in the art that changes could be made to the embodiments described above without departing from the broad inventive concept thereof. It is understood, therefore, that the invention disclosed herein is not limited to the particular embodiments disclosed and is intended to cover modifications within the spirit and scope of the present invention.

1. A computer-implemented method for a surveillance means (SM) of a vehicle, comprising:
recognizing at least one object via at least one SM, the SM recording image data of at least parts of surroundings of the vehicle;
determining, via the SM and/or the image data, properties of the object, the determining comprising a relative position of the object relative to the vehicle;
tracking, via the SM and/or the image data, if the object has disappeared from at least one surveillance area (SA) of the SM at least partly into a region not covered by the SA;
monitoring, via the SM and/or the image data, if the object is going to be or is completely outside a tracking area, the tracking area comprising the at least one region; and
providing a signal to a driver of the vehicle and/or preventing or allowing a change of movement direction of the vehicle based on the tracking, monitoring, and/or the relative position of the object.

2. The computer implemented method of claim 1, wherein at least one of:
the relative position comprises a distance and/or trajectory;
the region is a region on the rear of the vehicle and/or wherein the region is at least partly formed by at least one obstacle;
the at least one tracking area additionally comprises the SA; or
the obstacle is a trailer and/or attachment to the vehicle, wherein the attachment is affixed via a trailer connector.

3. The computer implemented method according to claim 1, wherein at least one of:
the SM comprises one or more cameras and the one or more SA is one or more field of views (FOVs) of the cameras;
the SM comprises a camera monitoring system (CMS);
the region is at least partly formed as blind area between at least two SAs of the SM, where the at least two SAs have an overlap; or
the SA and/or the at least two SAs is/are monitoring the rear part of the vehicle;
wherein the SM or the CMS comprise at least one first camera and/or at least one second camera, wherein the first camera and the second camera are positioned each at a rearview device or are part of or forming a rearview device and/or the first camera is associated with the at least one FOV and the second camera is associated with the other FOV.

4. The computer implemented method of claim 1, wherein at least one of:
the recognizing is aided by at least one first trained artificial intelligence model;
the determining is aided by the first and/or at least one second trained artificial intelligence model;
the tracking is aided by the first, second and/or at least one third trained artificial intelligence model; or
the monitoring is aided by the first, second, third and/or at least one fourth trained artificial intelligence model.

5. The computer implemented method of claim 1, wherein
the recognizing and/or the determining further comprises:
classifying the object into at least one object category, wherein one or more or each object category is assigned to a risk category, wherein the signal to a driver of the vehicle and/or the preventing or the allowing of a change of movement direction of the vehicle is based on the risk category, wherein the object category comprises at least one of: immovable objects, and movable objects, and/or wherein the risk category comprises at least one of: normal, vulnerable and/or very vulnerable.

6. The computer implemented method of claim 1, wherein the recognizing further comprises and/or the classifying the object into at least one object category comprises:
identifying and/or classifying the object recognized, using in a database of standard objects, other standardized objects of traffic infrastructure, wherein the identifying is supported by at least one of the first to fourth artificial intelligence model and/or a fifth artificial intelligence model.

7. The computer implemented method of claim 4,
wherein at least one of the first, second, third, fourth and/or fifth artificial intelligence model is a neural network (NN) and/or a classification algorithm; and/or
wherein the training data of any combination of the first to fifth artificial intelligence model comprises:
image data of different objects that move into the region via at least partly crossing and/or partly moving into one or more SAs of one or more SMs of different vehicles at different distances and/or with different trajectories relative to the vehicles; and/or
image data, in particular images, using different obstacles.

8. The computer implemented method of claim 1, wherein the determining further comprises at least one of:
determining at least one of: the dimensions of the object, the relative velocity of the object relative to the object and/or an object type; or
saving at least partly, preferably completely, the properties of the object, preferably for and/or during the monitoring and/or tracking.

9. The computer implemented method of claim 1, wherein the tracking further comprises:
determining based on the properties of the object at least one of: a minimal distance relative to the vehicle and/or a maximum width, maximum height and/or maximum length of the object; and
saving the minimal distance and the maximum dimension for or during the monitoring and/or tracking.

10. The computer implemented method of claim 1, wherein the method further comprises receiving/acquiring from a database at least one of:
dimensions of the obstacle, including width, height and/or length,
dimensions of vehicle, including width, height and/or length,
the position of the first and/or second camera on the vehicle, or
the position of rearview devices carrying the first and/or second camera;
wherein the method further comprises defining the region based on at least one of:
dimensions of the obstacle, including width, height and/or length,
dimensions of vehicle, including width, height and/or length,
the position of the first and/or second camera on the vehicle, or
the position of rearview devices carrying the first and/or second camera.

11. The computer implemented method of claim 3, wherein the method further comprises adjusting the region based at least on one of:
the trajectory of the vehicle, wherein the SA and/or the at least two SAs are changed due to the vehicle changing its steering direction and/or movement direction;
the obstacle dimensions; or
the overlap of the at least two SA, which defines the distal end of the region relative to the vehicle.

12. The computer implemented method of claim 1, wherein
providing a signal further comprises at least one of:
determining that the object is at least partly in the region before providing the signal in form of a first signal or preventing change of movement direction;
determining that the object has left the region entirely before providing the signal in form of a second signal or allowing a change of movement direction; or
constructing the signal as birds eye view from the image data of the SM, wherein the region is visualized based on the determining.

13. The computer implemented method of claim 11, wherein monitoring and/or determining that the object is at least partly in the region and/or the determining that the object has left the region entirely before providing the signal in form of a second signal or allowing a change of movement direction, is based on a prediction using the object properties and/or is based at least one of:
the object properties, including the maximum dimension of the object including maximum width and/or maximum length,
the minimal distance relative to the vehicle,
a minimal distance threshold depending on the obstacle dimension, including the minimal distance threshold;
the dimensions of the obstacle, including width, height and/or length;
the dimensions of vehicle, including width, height and/or length;
the position of the first and/or second camera on the vehicle and/or the position of rearview devices carrying the first and/or second camera; or
the overlap, which defines the distal end of the region relative to the vehicle, wherein the distance upon overlap is determined and provides a maximum distance threshold.

14. The computer implemented method of claim 1, wherein the method further comprises at least one of
evaluating at least one sensor information for determining that the object is at least partly in the region, wherein the at least one sensor information is provided by the vehicle and/or the obstacle and/or is at least one of: park distance control sensor, GPS, radar signal, a laser signal, or a LIDAR signal; or
cleaning the object from a memory of the SM, based on the monitoring and/or the relative position after determining that the object has left the tracking area entirely.

15. A surveillance means (SM) for a vehicle comprising one or more processors in operational connection with at least one memory, the SM and/or one or more processors are configured to conduct the method according to claim 1.

16. The surveillance means of claim 14, wherein at least one of
the SM comprises at least one CMS and/or a first and a second camera positioned each at a rear view device; or
the SM comprises at least one sensor, including a park distance control sensor, GPS sensor, a radar sensor, a laser sensor, or a LIDAR, wherein the sensor is positioned on the vehicle and/or the obstacle.

17. A vehicle configured with at least one SM and configured to conduct the method according to claim 1.

18. A computer program comprising instructions which, when the program is executed by a computer, cause the computer to carry out the method according to claim 1.

19. A computer-readable medium comprising instructions which, when executed by a computer, cause the computer to carry out the method according to claim 1.
